(19) United States
(12) Patent Application Publication
(10) Pub. No.: US 2014/0253034 A1
(43) Pub. Date: Sep. 11, 2014

(54) CHARGE SYSTEM FOR ELECTRIC VEHICLES

(71) Applicant: DENSO CORPORATION, Kariya-city (JP)

(72) Inventors: Masayuki Kurimoto, Obu-city (JP); Takashi Kanamori, Nagoya-city (JP)

(73) Assignee: DENSO CORPORATION, Kariya-city (JP)

(21) Appl. No.: 14/202,009

(22) Filed: Mar. 10, 2014

(30) Foreign Application Priority Data
Mar. 11, 2013 (JP) 2013-048081

(51) Int. Cl. B60L 11/18

(52) U.S. Cl. CPC B60L 11/1824; B60L 11/182
USPC 320/109

(57) ABSTRACT

A charging system for batteries on electric vehicles includes: a first distributer providing electricity supplying passages, through which a normal speed charging device charges a part of batteries in parallel in a normal speed charging process; a second distributer providing a selective electricity supplying passage, through which a rapid charging device charges one battery in a rapid charging process; and a controller. The controller includes: a charging order control device controlling the second distributer to switch the selective electricity supplying passage according to a charging order; a secondarily charging device controlling the normal speed charging device to secondarily charge the one battery in the normal speed charging process after the rapid charging process; and an alternative charging device controlling the normal speed charging device to alternatively charge another battery in the normal speed charging process while waiting for the rapid charging process.

### CROSS REFERENCE TO RELATED APPLICATION

This application is based on Japanese Patent Application No. 2013-48081 filed on Mar. 11, 2013, the disclosure of which is incorporated herein by reference.

### TECHNICAL FIELD

The present disclosure relates to a charge system for charging multiple electric vehicles effectively from a charge station.

### BACKGROUND

Patent documents No. 1 to No. 3 relate to a charge system for multiple electric vehicles from a charge station. Patent document No. 1 teaches a system including a power supplying circuit for charging rapidly and a power supplying circuit for charging with a normal speed. Patent document No. 2 teaches a system for setting a charging order in multiple electric vehicles and for switching a charging circuit. Patent document No. 3 teaches a system for charging one electric vehicle via an insulation type charging circuit and for charging another electric vehicle via a non-insulation type charging circuit at the same time.

In the above technique, one of the rapid charging way and the normal speed charging way is selected. Accordingly, one electric vehicle is charged in only one of the rapid charging manner or the normal speed charging manner. However, when it is necessary to charge multiple vehicles in the rapid charging manner at the same time, waiting time occurs. In this case, the waiting time becomes long. On the other hand, it is preferable to reduce the number of rapid charging devices because of a running cost of a charging station or an economical running efficiency of the charging station. Further, it is difficult to increase the number of electric vehicles that are capable of being charged rapidly at the same time. In view of these points, it is necessary to improve a charging system for an electric vehicle.

(Patent document No. 1) JP-A-2010-28913

(Patent document No. 2) JP-A-2011-24334

(Patent document No. 3) JP-A-2012-152029 (corresponding to US 2012/0181990-A1)

### SUMMARY

It is an object of the present disclosure to provide a charging system for an electric vehicle, which charges multiple electric vehicles efficiently. The charging system for an electric vehicle charges multiple electric vehicles efficiently even when the number of electric vehicles is larger than the number of rapid charging devices. Further, the charging system for an electric vehicle charges multiple electric vehicles in a short time using a rapid charging device and a normal charging device.

According to an example aspect of the present disclosure, a charging system for charging a plurality of batteries mounted on a plurality of electric vehicles, respectively, the charging system includes: a first distributer that provides a plurality of parallel electricity supplying passages, through which a normal speed charging device charges a part of the batteries in parallel in a normal speed charging process; a second distributer that provides a selective electricity supplying passage, through which a rapid charging device charges one of the batteries selectively and switchably in a rapid charging process, the rapid charging device charging the one of the batteries with a charging speed higher than the normal speed charging device; and a controller for controlling the first distributer and the second distributer. The controller includes: a charging order control device that controls the second distributer to switch the selective electricity supplying passage according to a charging order of the batteries in the rapid charging process, so that the rapid charging device executes the rapid charging process in turn; a secondarily charging device that controls the normal speed charging device to secondarily charge the one of batteries in the normal speed charging process after the rapid charging device charges the one of batteries in the rapid charging process; and an alternative charging device that controls the normal speed charging device to alternatively charge at least another one of batteries in the normal speed charging process when the at least another one of batteries waits for the rapid charging process.

In the above system, the selective electricity supplying passage is formed between the rapid charging device and one of the batteries, and the selective electricity supplying passage is switched from one of the batteries to another one of the batteries. Accordingly, one rapid charging device can charge multiple vehicles in turn. Further, the parallel electricity supplying passages are formed between the normal speed charging device and the vehicles. The normal speed charging device secondarily charges the one of batteries in the normal speed charging process after the rapid charging process so that the charging state of the one of the batteries is increased. Furthermore, the normal speed charging device alternatively charges the another one of the batteries in the normal speed charging process while waiting for the rapid charging process.

Accordingly, the system can charge multiple electric vehicles efficiently even when the number of electric vehicles is larger than the number of rapid charging devices. Further, the charging system can charge multiple electric vehicles in a short time using the rapid charging device and the normal speed charging device.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a charging system for an electric vehicle according to a first embodiment;

FIG. 2 is a block diagram showing a charging path according to the first embodiment;

FIG. 3 is a flowchart showing a charging control process according to the first embodiment;

FIG. 4 is a flowchart showing a power receiving control process according to the first embodiment;

FIG. 5 is a diagram showing a timing chart of an operation according to the first embodiment;

FIG. 6 is a diagram showing a timing chart of another operation according to the first embodiment;

FIG. 7 is a block diagram showing a charging system for an electric vehicle according to a second embodiment; and

FIG. 8 is a block diagram showing a charging path according to the second embodiment.

### DETAILED DESCRIPTION

Embodiments of the present disclosure will be explained with reference to the drawings. In each embodiment, an element corresponding to a feature described in a previous embodiment may have the same reference numeral as the previous embodiment, and therefore, the explanation of the element may be skipped. When a part of a feature in each embodiment is described, other parts of the feature may be described in previous embodiments. An element in following embodiments has a reference numeral, which is attached by adding a hundreds digit into the reference numeral of a corresponding feature described in a previous embodiment, so that a relationship between the element and the corresponding feature is shown. In this case, the redundant explanation of the element may be skipped. A combination of elements in embodiments may be clearly described. Alternatively, even when another combination of elements is not clearly described in the embodiments, the another combination of elements may be feasible as long as the another combination does not include inconsistency.

### First Embodiment

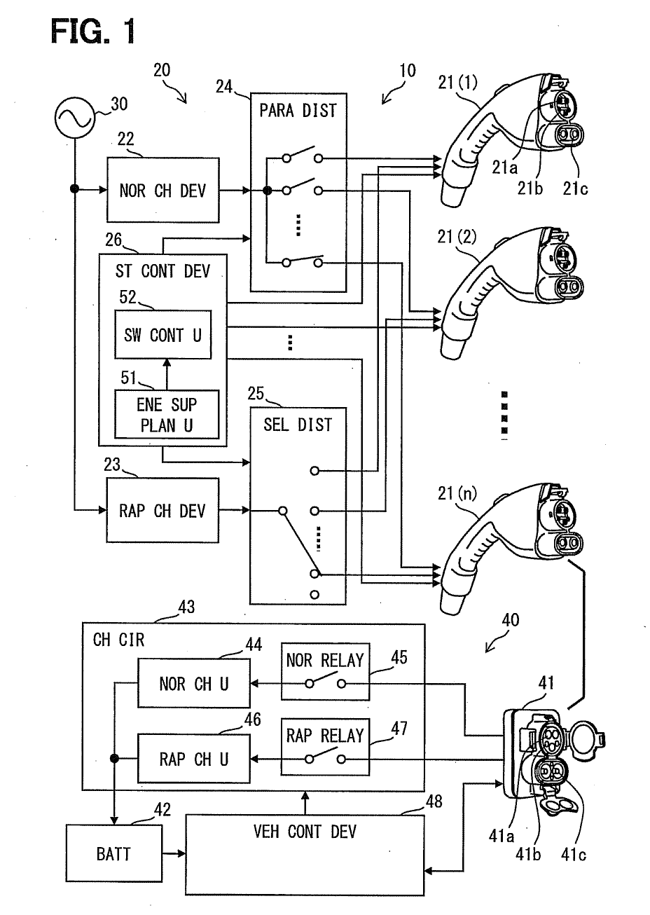

FIG. 1 shows a charging system 10 for an electric vehicle according to a first embodiment of the present disclosure. The system 10 includes a charging station 20 and an electric vehicle 40. The charging system 10 charges a battery mounted on the vehicle 40 by electricity supplied from a power source 30. The power source 30 may be a commercial power source for supplying electricity via a wide area power network or a small-scale electric power facility. The power source 30 supplies alternating current electricity.

The charging station 20 is a charging device arranged at a private house or a business facility. The charging station 20 is owned by a person, who has an electric vehicle, or the station 20 is a commercial facility for selling electricity. The electric vehicle 40 moves by an electric power system including a battery and an electric motor. The vehicle 40 is, for example, an electric vehicle that moves using only electricity, a plug-in hybrid vehicle that includes an engine system such as an internal combustion engine in addition to the electric system.

The charging station 20 is capable of charging multiple electric vehicles 40 equal to or more than one vehicle in parallel. The charging station 20 includes multiple connectors 21. In FIG. 1, the charging station 20 includes N connectors 21. In FIG. 1, a first connector is defined as 21(1), a second connector is defined as 21(2), and a n-th connector is defined as 21(n). In the following explanation, when the number in a bracket is the same, an element belongs to the same device. The connector 21 includes a coupler for charging in a normal speed and a coupler for charging in a high speed.

The coupler for charging with the normal speed includes multiple electric terminals 21a for charging in a normal speed. The electric terminals 21a include a pair of alternating current terminals for supplying alternating current electricity and a ground terminal. The coupler for charging normally, i.e., in a normal speed, includes a communication terminal 21b for executing data communication. The coupler for charging rapidly, i.e., in a high speed, includes multiple power terminals 21c for charging in the high speed. Multiple power terminals 21c may include a pair of direct current terminals for supplying direct current electricity. The connector 21 is a complex type connector 21 having a group of terminals for executing a normal speed charging process and a group of terminals for executing a high speed charging process. The connector 21 may be defined as a Combo connector.

The charging station 20 includes a normal charging device 22 for converting the alternating current electricity supplied from the power source 30 to a voltage, which is suitable for charging the electric vehicle 40. The normal charging device 22 outputs the alternating current electricity to be supplied to the power terminal 21a. When the vehicle 40 is energized from the normal charging device 22, a battery of the vehicle 40 can be charged up to a maximum level, i.e., the battery can be fully charged, for example.

Since the normal charging device 22 supplies the alternating current to the vehicle 40, so that the device 22 is defined as an alternating current charging device. Further, the electricity supplied to the connector 21 from the normal charging device 22 is smaller than the electricity supplied to the connector 21 from the rapid charging device 23. Accordingly, the charging speed of the normal charging device 22 is smaller than the charging speed of the rapid charging device 23. The normal charging device 22 supplies the electricity for charging in a comparative low speed, so that the device 22 is defined as a low speed charging device.

The charging station 20 includes a rapid charging device 23 for converting the alternating current electricity from the power source 30 to a voltage, which is suitable for supplying to the electric vehicle 40. The rapid charging device 23 charges the battery 42 of the vehicle 40 with a speed higher than the normal charging device 22. The rapid charging device 23 outputs the direct current electricity to be supplied to the power terminal 21c. The rapid charging device 23 includes an AC/DC converter. Further, the rapid charging device 23 may include an independent power source device for charging rapidly. For example, the rapid charging device 23 may include a battery for supplying a large amount of the direct current electricity. When the rapid charging device 23 supplies the electricity, the electric vehicle 40 can be charged up to a certain upper limit UL, which is lower than the maximum level of the battery. The certain upper limit UL may be set for protecting the battery. The upper limit UL may be set to be equal to 80 percents of the charge state, which is lower than the full charge state, for example.

The rapid charging device 23 supplies the direct current electricity to the vehicle 40, and therefore, the device 23 is defined as the direct current charging device. Further, the electricity supplied to the connector 21 from the rapid charging device 23 is larger than the electricity supplied to the connector 21 from the normal charging device 22. Accordingly, the charging speed of the rapid charging device 23 is higher than the charging speed of the normal charging device 22. Since the rapid charging device 23 supplies the electricity for charging rapidly, the rapid charging device 23 is defined as the high speed charging device.

The charging station 20 includes a parallel distributer 24 for distributing the electricity to multiple connectors 21 from the normal charging device 22. The parallel distributer 24 provides a power supply passage from the normal charging device 22 to multiple connectors 21 in parallel to each other. The parallel distributer 24 is capable of supplying the electricity to multiple vehicles 40 at the same time. Since the parallel distributer 24 distributes the electricity for executing the normal speed charging process, the distributer 24 is defined as a distributer for the normal speed charging process. Further, the distributer 24 distributes the alternating current electricity for the normal speed charging process, and therefore, the distributer 24 is defined as an alternating current distributer.

The parallel distributer 24 is provided by multiple switches, which close the line at the same time. Each switch corresponds to a respective one connector 21. Each switch is capable of connecting and disconnecting a charge passage between the normal charging device 22 and a respective one connector 21. Each connector 21 is connected to the vehicle 40 via a respective one switch of the parallel distributer 24, and, when the normal speed charging process is available properly, the switch is closed. When multiple connectors 21 and multiple vehicles 40 are connected to each other, respectively, multiple switches are closed. Thus, the normal charging device 22 is capable of supplying electricity to multiple vehicles 40 in parallel. The parallel distributer 24 provides a first distributing unit that forms a parallel energizing passage, through which the normal charging device 22 supplies electricity to multiple batteries 42.

The charging station 20 includes a selective distributer 25 for distributing electricity from the rapid charging device 23 to multiple connectors 21. The selective distributer 25 forms a selective energizing passage from the rapid charging device 23 to multiple connectors 21. The selective distributer 25 can supply electricity to one of the vehicles 40, which is selected among multiple vehicles 40. Since the selective distributer 25 distributes electricity for executing the rapid charging process, the selective distributer 25 is defined as a distributer for rapid charging process. Further, since the selective distributer 25 distributes the direct current electricity for charging rapidly, the selective distributer 25 is defined as a direct current distributer.

The selective distributer 25 is provided by a unipolar multiple throw switch or a single-pole multiple-throw switch. The selective distributer 25 as the unipolar multiple throw switch is defined as a selective switch. The rapid charging device 23 is connected to a common contact point, and multiple connectors 21 are connected to multiple contact points, respectively. The selective distributer 25 connects the rapid charging device 23 and one of connectors 21, which is connected to one of vehicles 40 selected among multiple vehicles 40. Thus, the rapid charging device 23 is capable of supplying electricity to only one vehicle 40. The selective distributer 25 provides a second distributing unit that forms a selective energizing passage from the rapid charging device 23 capable of selecting one battery 42 among multiple batteries 42 and being switchable from one battery 42 to another battery 42.

The charging station 20 includes a station control device 26. The station control device 26 is arranged at the charging station 20. The station control device 26 controls each device of the charging station 20 such as the normal charging device 22, the rapid charging device 23, the parallel distributer 24 and the selective distributer 25. The station control device 26 communicates with the vehicles 40, which are connected via the connectors 21.

The station control device 26 includes an electricity supply planning unit 51 for setting an electricity supply plan relating to a charging process of the vehicles 40, which are connected to the charging station 20. The electricity supply planning unit 51 makes a plan about a supply timing of the normal charge and a supply timing of the rapid charge according to multiple conditions with regard to each vehicle 40 connected to the charging station 20. The supply timing is defined by a supply start time and a supply end time. The electricity supply planning unit 51 is defined as a schedule setting unit for setting a schedule for charging multiple vehicles 40 when multiple vehicles 40 are connected to the charging station 20.

The electricity supply planning unit 51 sets at least an order for executing the rapid charge with respect to multiple vehicles 40. The electricity supply planning unit 51 determines a part of vehicles 40, which is capable of being charged with a normal speed (i.e., to which the electricity is supplied in a rapid charging manner), after the rapid charge is performed or while the rapid charge is performed. The electricity supply planning unit 51 sets the charge plan such that the part of vehicles 40, which is not charged with a high speed (i.e., to which the electricity is not supplied in a rapid charging manner), is charged in the normal charging manner. Further, the electricity supply planning unit 51 restricts the number of vehicles 40, which is charged in the normal charging manner, so as not to exceed a receiving electricity capacity that is a maximum electricity received from the power source 30. For example, when the maximum electricity supplied from the power source 30 is limited to a contract electricity that is agreement about the receiving electricity, the electricity supply planning unit 51 limits the number of vehicles 40, which is charged in the normal charging manner, so as not to exceed the contract electricity.

The station control device 26 includes a switching control unit 52 for controlling the parallel distributer 24 and the selective distributer 25 in order to charge the vehicles 40 connected to the charging station 20. The switching control unit 52 controls the parallel distributer 24 and the selective distributer 25 based on the electricity supply plan set by the electricity supply planning unit 51. The switching control unit 52 controls the parallel distributer 24 to charge one or more vehicles 40, which is selected by the electricity supply planning unit 51, in the normal charging manner. The switching control unit 52 controls the selective distributer 25 to charge only one of the vehicles 40, which is selected by the electricity supply planning unit 51, in the rapid charging manner. The switching control unit 52 switches the selective distributer 25 to charge another vehicle 40 according to the order determined by the electricity supply planning unit 51.

The electricity supply planning unit 51 and the switching control unit 52 provide a controller for controlling the parallel distributer 24 and the selective distributer 25. The controller controls the parallel distributer 24 and the selective distributer 25 to execute the normal speed charging process with the normal charging device 22 after the rapid charging device 23 executes the rapid charging process. The controller controls the selective distributer 25 to switch vehicles 40 connecting to the rapid charging device 23 in turn when multiple vehicles 40 are connected to the charging station 20. Thus, the controller provides the rapid charging process to multiple vehicles 40 in turn. Further, the controller controls the parallel distributer 24 to execute the normal charging process for vehicles 40, which wait for the rapid charging process.

Each vehicle 40 includes an inlet 41 corresponding to the connector 21. The inlet 41 includes a coupler for connecting to the coupler of the connector 21. Thus, the inlet 41 includes a coupler for the normal charging process and a coupler for the rapid charging process.

The coupler for the normal charging process includes multiple power terminals 41a for charging in the normal charging manner. Multiple power terminals 41a include a pair of alternating current terminals for receiving the alternating current electricity and a ground terminal. The coupler for the normal charging process includes a communication terminal 41b for executing the data communication. The coupler for the rapid charging process includes multiple power terminals 41c for the rapid charging process. Multiple power terminals 41c include a pair of direct current terminals for receiving the direct current electricity. The inlet 41 is a complex type inlet corresponding to the connector 21.

The connector 21 and the inlet 41 provide a connecting device for connecting the charging station 20 and the vehicles 40. The charging system 10 includes multiple connecting devices described above. In each connecting device, the power terminals 21a, 41a for connecting the normal charging device 22 and the vehicles 40 and the power terminals 21c, 41b for connecting the rapid charging device 23 and the vehicles 40 are arranged.

Each vehicle 40 includes a battery 42 as a driving power source for driving the vehicle 40. The battery 42 supplies the electricity to a driving electric motor of the vehicle 40. The battery 42 is provided by a lithium ion battery having a large amount of capacity.

Each vehicle 40 includes a charging circuit 43. The charging circuit 43 charges the battery 42 with the electricity supplied via the inlet 41.

The charging circuit 43 includes a normal charging unit 44 for charging the battery 42 with the electricity supplied from the power terminal 41a. The normal charging unit 44 can charges the battery fully. In the present embodiment, the full charge state has a charge amount of 100 percents in the charge state. The normal charging unit 44 includes an AC/DC converter. The charging circuit 43 includes a normal relay 45 arranged between the power terminal 41a and the normal charging unit 44. The normal relay 45 connects and disconnects the electricity supply passage for the normal speed charging process.

The charging circuit 43 includes a rapid charging unit 46 for charging the battery 42 with the electricity supplied from the power terminal 41c. The rapid charging unit 46 can charge the battery up to the upper limit UL. In the present embodiment, the upper limit corresponds to a charge amount of 80 percents. The charging circuit 43 includes a rapid relay 47 arranged between the power terminal 41c and the rapid charging unit 46. The rapid relay 47 connects and disconnects the electricity supply passage in the vehicle 40 for the rapid charging process.

The vehicle 40 includes a vehicular control device 48. The vehicular control device 48 controls the charging circuit 43. The vehicular control device 48 communicates with the charging station 20 via the inlet 41.

The station control device 26 and the vehicular control device 48 provide a control apparatus for controlling the charging system 10. The station control device 26 and the vehicular control device 48 are an electronic control unit (i.e., ECU). The control apparatus includes a central processing unit (i.e., CPU) and a memory as a storage medium for storing a program. The control apparatus is provided by a micro computer having a computer readable storage medium. The storage medium stores a program, which is readable by a computer sustainably (i.e., not temporarily). The storage medium is provided by a semiconductor memory or a magnetic disk. The program is executed by the control apparatus, so that the control apparatus functions as a system and the control apparatus executes a control method for the system. An element in the control apparatus may be defined as a functional block or a module for achieving a predetermined function.

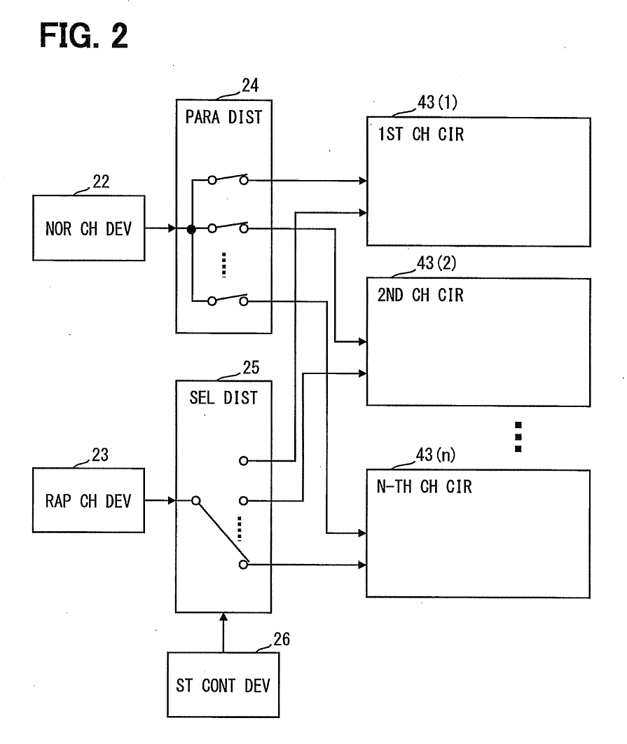

As shown in FIG. 2, when multiple vehicles 40 are connected to the charging station 20, the electricity supply passage for the normal speed charging process and the electricity supply passage for the rapid charging process are formed. Multiple electricity supply passages are formed in parallel to each other between the normal charging device 22 and multiple charging circuits 43. Multiple electricity supply passages are formed selectively and switchably between the rapid charging device 23 and multiple charging circuits 43. Multiple electricity supply passages for the rapid charging process are selectively closed by the selective distributer 25 arranged in the station 20. In this case, the selective distributer 25 provides selective and switchable electricity supply passage between the rapid charging device 23 and multiple vehicles 40. In the drawings, only the electricity supply passage between the rapid charging device 23 and the n-th charging circuit 43(n) is closed. In the drawings, only the n-th charging circuit 43(n) can charge the vehicle 40 in the rapid charging manner. Thus, the first charging circuit 43(1), the second charging circuit 43(2), and the (n−1)-th charging circuit 43(n−1) cannot charge the vehicles in the rapid charging manner. Thus, the first charging circuit 43(1), the second charging circuit 43(2), and the (n−1)-th charging circuit 43(n−1) can charge the vehicles in the normal speed charging manner.

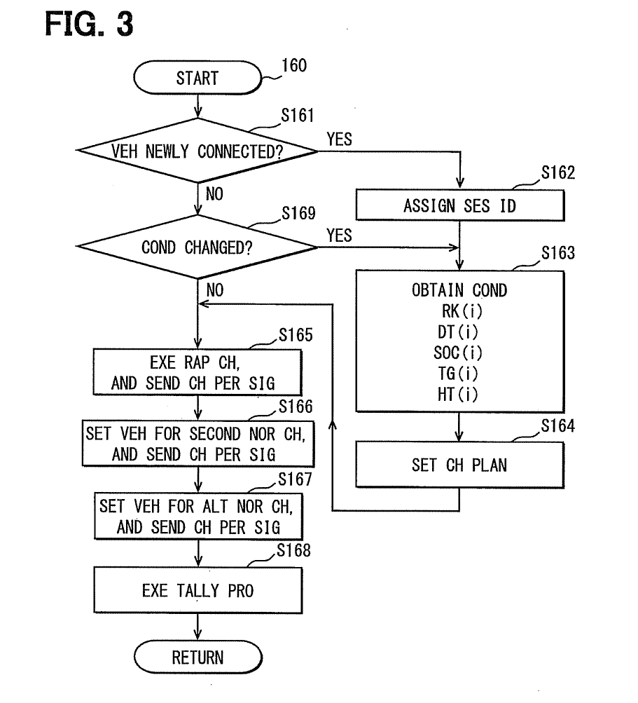

FIG. 3 shows a flowchart of an electricity supply controlling process (i.e., a charging control process) 160. The electricity supply controlling process 160 is executed by the station control device 26. The electricity supply controlling process 160 provides the electricity supply planning unit 51 and the switching control unit 52.

At step S161, the station control device 26 determines whether a vehicle 40 is newly connected to the station 20. When one of the connectors 21 is connected to the inlet 41 of the vehicle 40, it goes to step S162.

At step S162, the control device 26 assigns a session ID to a newly connected vehicle 40. The session ID is used for identifying the vehicles 40 in the station 20 while the vehicles are connected to the station 20. For example, session ID is used for calculating a fee of the normal charging process and a fee of the rapid charging process, which are provided to one vehicle 40.

At step S163, the station control device 26 inputs and obtains multiple conditions, which are necessary to set the charging plan. The conditions may include information used for determining the order of the rapid charging process and the normal charging process.

The conditions includes a rank RK(i) of an user of the vehicle 40. The rank RK(i) is used for setting the order of the rapid charging process, for example. For example, when the user of the vehicle 40 has excellent credit information, the rank RK(i) of the vehicle 40 is high so that the order of the rapid charging process is prioritized. Further, when the user of the vehicle 40 utilizes the charging station 20 frequently, the rank RK(i) of the vehicle may be high.

The conditions may include a departure time DT(i), at which the vehicle 40 is scheduled to start driving. The departure time DT(i) is obtained from an action schedule of the user or an input operation of the user.

The conditions may include an initial charging state SOC(i), which shows the charging state (i.e., state of charge, SOC) of the vehicle before charging. Based on the initial charging state SOC(i), the electricity for fully charging the vehicle 40 from the initial state, the period until fully charging the vehicle 40 and the like are calculated. When multiple vehicles 40 are connected to the station 20, multiple initial charging states SOC(i) corresponding to multiple vehicles 40 are input and obtained.

The conditions may include a target charging state TG(i). The target charging state TG(i) is obtained from the action schedule of the user or the input operation of the user.

The conditions may include a rapid charge available time HT(i), which is available time for charging the vehicle in the rapid charging manner. The rapid charge available time HT(i) may be variable according to the charging circuit 43.

The conditions may additionally or alternatively include information about the type and the model of the battery, and/or information about the capacity of the battery.

At step S164, the station control device 26 sets the electricity supply plan (i.e., charging plan) based on the conditions obtained at step S163. At step S164, an order setting unit for setting the order of the rapid charge is provided so that the order of the rapid charging process is determined based on a condition. As a result, at step S164, at least the providing schedule of the rapid charging process is planned. Further, at step S164, a restriction unit is provided such that the restriction unit restricts the number of vehicles to be charged in the normal speed charging manner so that the supply electricity from the power source 30 to the normal charging device 22 and the rapid charging device 23 falls below a predetermined upper limit.

When only one vehicle 40 is connected to the station 20, at step S164, the charging plan is set such that the vehicle 40 is secondarily charged by the normal charging device 22 in the normal speed charging manner after the vehicle 40 is charged by the rapid charging device 23 in the rapid charging manner. The secondarily normal charging process is executed so as to increase the charging state, which is higher than a level of the fully charging state of the rapid charging manner.

When multiple vehicles 40 are connected to the station 20, at step S164, the charging plan is set such that multiple vehicles 40 are charged selectively in the rapid charging manner. In this case, at step S164, the plan is set that multiple vehicles 40 are charged in parallel in the normal speed charging manner. In this case, the charging plan is also set such that the vehicle 40 is secondarily charged by the normal charging device 22 in the normal speed charging manner after the vehicle 40 is charged by the rapid charging device 23 in the rapid charging manner. Further, the charging plan is set such that the battery 42 of the vehicle 40, which waits for the rapid charging process executed by the rapid charging device 23, is charged by the normal charging device 22 in the normal speed charging manner alternatively. The alternative normal charging process is executed instead of the rapid charging process so as to increase the charging state of the battery 42 of the vehicle 40 while the vehicle 40 waits for the rapid charging process. The alternative normal charging process is defined as a preliminary charging process.

Further, at step S164, the plan is set such that the number of vehicles 40 to be charged in the normal charging manner at the same time is restricted. Here, the number of the vehicles 40 to be charged in the normal speed charging manner is restricted so that the electricity does not exceed the receiving electricity capacity supplied from the power source 30, i.e., so that the supplied electricity falls below a predetermined upper limit. Thus, the plan is set such that the number of the vehicles 40 to be charged in the normal speed charging manner is limited. The number of vehicles to be charged in the normal speed charging manner may be adjusted by reducing the number of the vehicles 40 to be charged by the secondarily normal charging process and reducing the number of the vehicles 40 to be charged by the alternative normal charging process. For example, the number of the vehicles 40 to be charged by the alternative normal charging process is maintained, and the number of the vehicles 40 to be charged by the secondarily normal charging process is restricted. Alternatively, the number of the vehicles 40 to be charged by the alternative normal charging process is restricted, and the number of the vehicles 40 to be charged by the secondarily normal charging process is maintained. In this case, at step S164, the number of the vehicles 40 to be charged by the alternative normal charging process is restricted based on a certain order. For example, the number of the vehicles 40 to be charged in the normal speed charging manner is restricted such that the vehicles 40 having the comparative low priority order is prohibited to be charged in the normal speed charging manner, or is postponed to be charged in the normal speed charging manner.

Specifically, the plan is set such that the vehicles 40 to be connected to the rapid charging device 23 are switched in turn. In this case, at step S164, the plan is set such that the vehicles waiting for the rapid charging process are charged in the normal speed charging manner. In this case, the plan is set such that the vehicles 40 are charged by the normal charging device 22 in the normal speed charging manner after the vehicles 40 are charged by the rapid charging device 23 in the rapid charging manner. Further, the plan is set such that the number of the vehicles 40 to be charged in the normal speed charging manner falls below a predetermined number of vehicles 40.

In steps S165 to S167, the station control device 26 executes the electricity supply process for supplying the electricity to the vehicles 40. Specifically, in steps S165 to S167, the parallel distributer 24 and the selective distributer 25 are controlled. Here, based on the electricity supplying plan set at step S164, the parallel distributer 24 and the selective distributer 25 are controlled. At step S165, the station control device 26 controls the selective distributer 25 to provide the rapid charging process to multiple vehicles 40 selectively. In steps S166 to S167, the station control device 26 controls the parallel distributer 24 to provide the normal charging process to multiple vehicles 40 in parallel.

At step S165, the station control device 26 sends a signal showing permission of the rapid charging process to one of the vehicles 40, which is selected as a permitted vehicle for the rapid charging process. At step S165, the station control device 26 receives a completion signal of the rapid charging process from the vehicular control device 48 of the one of the vehicles 40. At step S165, the station control device 26 executes to switch the electricity supply passage selectively in response to the completion signal. At step S165, the station control device 26 executes to switch from the signal for permitting the rapid charging process to a signal for permitting the normal charging process in response to the completion signal. Steps S163 to S165 provide an order control unit for switching the electricity supply passage in turn selectively based on the charging order of the vehicles 40, so that the order control unit provides the rapid charging process with the rapid charging device 23 according to the charging order.

At step S166, the station control device 26 sends the signal for permitting the normal charging process with respect to the vehicles 4 that have been already charged in the rapid charging process (i.e., the vehicles 40, which the rapid charging process is completed with respect to). At step S166, the station control device 26 receives the completion signal of the rapid charging process from the vehicular control device 48 of the vehicle 40. At step S166, the station control device 26 sends the signal for permitting the normal charging process in response to the completion signal for the rapid charging process. Further, at step S166, the station control device 26 receives the completion signal of the normal charging process from the vehicular control device 48 of the vehicle 40. At step S166, the station control device 26 stops sending the signal for permitting the normal charging process in response to the completion signal of the normal charging process. Step S166 provides a secondarily charging unit for providing the normal charging process secondarily with the normal charging device 22 after the rapid charging device 23 performs the rapid charging process.

At step S167, the station control device 26 sends the signal for permitting the normal charging process to the vehicle 40 that waits for the rapid charging process. In the present embodiment, when it is necessary to charge multiple vehicles 40 in the rapid charging manner, the vehicle 40 having the low priority is in a waiting state for the rapid charging process. Although the vehicle 40 having the low priority is capable of being charged in the rapid charging manner, the vehicle 40 is not charged in the rapid charging manner at that time because of the low priority. Step S167 provides the normal charging process alternatively in stead of the rapid charging process to the vehicle 40 having the low priority. Step S167 provides an alternative charging unit for providing the normal charging process alternatively with the normal charging device 22 to the vehicle 40 that waits for the rapid charging process by the rapid charging device 23.

At step S168, the station control device 26 executes a tallying process. At step S168, the tallying process is performed at each session ID. As a result, even if both of the rapid charging process and the normal charging process are provided to one vehicle 40 through one series of charging service, a fee for the rapid charging process and a fee of the normal charging process are summed up, and the total fee of the rapid charging process and the normal charging process is charged to the user of the vehicle 40.

At step S161, when the station control device 26 determines that a vehicle 40 is not newly connected to the station 20, it goes to step S169. At step S169, the station control device 26 determines whether at least one of conditions is changed. For example, the departure time DT(i) may be changed frequently by the input operation of the user. When at least one of conditions is changed, it goes to step S163. Then, a changed condition is obtained. Then, steps S164 to S167 are executed again. Thus, based on the changed conditions, the electricity supplying plan is set again. Then, the parallel distributer 24 and the selective distributer 25 are controlled.

The changed conditions may include an operation to stop supplying the electricity. For example, the charging process may be interrupted by the operation of the user. Even when the charging process is interrupted, it goes to step S163. Then, steps S164 to S167 are executed again. Thus, the electricity supplying plan is set with respect to the conditions of other vehicles 40 except for the vehicle 40, at which the charging process is interrupted. Thus, the parallel distributer 24 and the selective distributer 25 are controlled. When the station control device 26 determines that no condition is changed, it goes to step S165. Thus, at step S164, the electricity supplying plan set at step S164 is continuously executed.

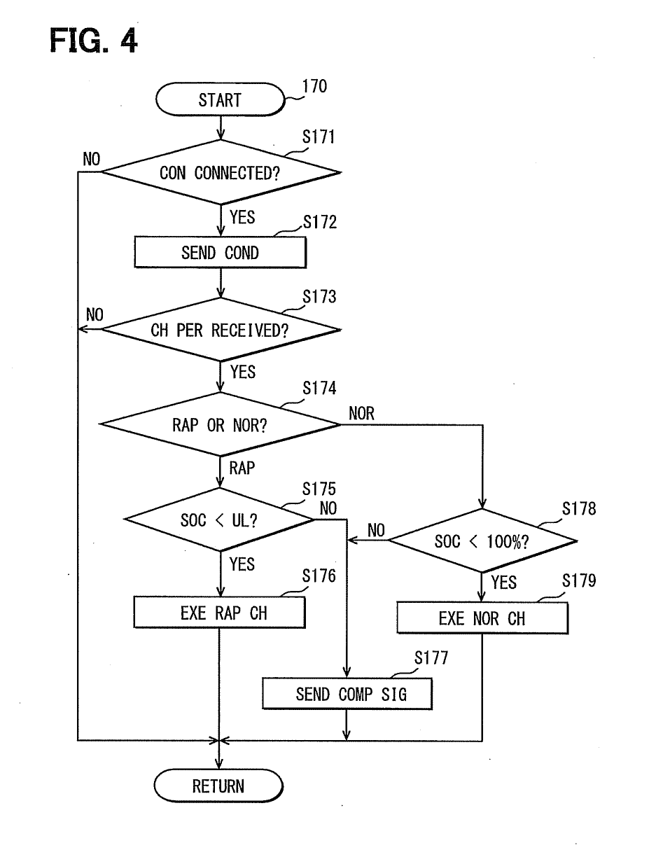

FIG. 4 shows a flowchart of a power receiving control process 170. The vehicular control device 48 executes the power receiving control process 170.

At step S171, the vehicular control device 48 determines whether the inlet 41 is connected to the connector 21. When the inlet 41 is not connected to the connector 21, other steps S172 to S179 are not executed. When the inlet 41 is connected to the connector 21, it goes to step S172.

At step S172, the vehicular control device 48 sends the conditions relating to the vehicle 40, which has the inlet 41 connected to the connector 21, to the station control device 26. At step 173, the vehicular control device 48 determines whether the signal for permission of the charging process is received from the station control device 26. When the permission for the charging process is not obtained, latter steps S174 to S179 are skipped. When the permission for the charging process is obtained, it goes to step S174.

At step S174, the vehicular control device 48 determines whether the permission for the normal charging process or the permission for the rapid charging process is obtained. When the permission for the rapid charging process is obtained, it goes to step S175. At step S174, when the permission for the normal charging process is obtained, it goes to step S178.

At step S175, the vehicular control device 48 determines whether the vehicle 40 is capable of being charged in the rapid charging process. Here, the device 48 determines whether the state of charge (SOC) of the vehicle 40 falls below the upper limit UL. When the state of charge (SOC) of the battery 42 in the vehicle 40 falls below the upper limit UL, the vehicle 40 is capable of being charged in the rapid charging process. Then, it goes to step S176.

At step S176, the vehicular control device 48 activates the rapid charging unit 46, and controls the rapid relay 47 to close so that the rapid charging process is executed. The battery 42 is rapidly charged by the large direct current supplied from the rapid charging device 23. Thus, while the rapid charging process is permitted, the vehicular control device 48 executes step S176 repeatedly until the state of charge SOC of the battery 42 reaches the upper limit UL.

Then, the rapid charging process proceeds, so that the state of charge SOC of the battery 42 reaches the upper limit UL. When the state of charge SOC reaches the upper limit UL, it goes to step S177 from step S175. At step S177, the vehicular control device 48 sends the completion signal, showing that the rapid charging process is completed, to the station control device 26. The signal showing the completion of the rapid charging process also functions as a signal for requesting to switch from the rapid charging process to the normal charging process.

When the completion signal of the rapid charging process is received, the station control device 26 executes to switch the selective electricity supplying passage. Further, the station control device 26 executes to switch from the signal for permission of the rapid charging process to the signal for permission of the normal charging process. As a result, when the power receiving control process 170 is repeated again, and at step S174, the permission for the normal charging process is obtained, so that to goes to step S178.

At step S178, the vehicular control device 48 determines whether the vehicle 40 is capable of being charged in the normal charging process. Here, the device 48 determines at step S178 whether the battery 48 is fully charged. Here, the device 48 determines whether the state of charge (SOC) of the vehicle 40 falls below the charge amount of 100 percents in the charge state. When the state of charge (SOC) of the battery 42 in the vehicle 40 falls below the 100 percent charge state, the vehicle 40 is capable of being charged in the normal charging process. Then, it goes to step S179.

At step S179, the vehicular control device 48 activates the normal charging unit 44, and controls the normal relay 45 to close, so that the normal charging process is executed. The normal charging unit 44 converts the alternating current electricity, which is supplied from the normal charging device 22, to the direct current electricity, so that the unit 44 charges the battery 42 with the direct current electricity. The battery 42 is charged with the converted direct current electricity until the battery 42 is fully charged. While the permission of the normal charging process is obtained, the vehicular control device 48 executes step S179 repeatedly until the charge of the battery 42 is completed.

Then, the normal charge proceeds, so that the state of charge SOC reaches the full charge, i.e., the 100 percentage charge state, it goes to step S177 from step S178. At step S177, the vehicular control device 48 sends the completion signal showing that the normal charging process ends to the station control device 26. The completion signal also functions as a signal for requesting the completion of the charging process. The signal showing the completion of the normal charging process also functions as a signal showing that a series of the charging process including the normal charging process is completed.

When the station control device 26 receives the completion signal of the normal charging process, the device 26 stops outputting the signal for permission of the charge. As a result, when the power receiving control process 170 is repeated again, and at step S173, since the permission for the charging process is not obtained, latter steps S174 to S179 are skipped. Thus, the normal charging process ends.

In the present embodiment, steps S163 to S164 provide the electricity supply planning unit 51. Further, steps S165 to S167 provide the switching control unit 52. Step S165 provides a switching control element for switching the selective electricity supplying passage in turn. Steps S166 to S167 provide a switching control element for forming the parallel electricity supplying passage.

Steps S162 and S168 provide a session management unit for handling the rapid charging process and the normal charging process as a series of a charging process. The session management unit continues to perform the communication even when the electricity supplying plan defines that the rapid charging process and the normal charging process are switched. A group of communication data, which passes through the communication terminals 21b, 41b before and after switching, is managed as a group of data for a series of charging services with respect to one vehicle 40. Thus, the summing process of a total fee that covers the fee of the rapid charging process and the fee of the normal charging process, and the billing process are performed.

Steps S163 to S164 provide a determination unit for determining the start timing of the rapid charging process with respect to the vehicle 40 having the highest priority (i.e., the highest charging order) at any time. In the present embodiment, the vehicle 40 having the low priority may exist. Although the vehicle 40 having the low priority can be charged in the rapid charging manner, the vehicle 40 can not be charged in the rapid charging manner because of the low priority. Steps S163 to S164 provide a determination unit for determining the start timing of the alternative normal charging process instead of the rapid charging process with respect to the vehicle 40 having the low priority.

Step S175 provides a determination unit for determining the end timing of the rapid charging process. Step S175 also provides a determination unit for determining the start timing of the normal charging process with respect to the vehicle 40 that has been charged in the rapid charging manner (i.e., the vehicle 40, which the rapid charging process is completed with respect to). The normal charging process after the rapid charging process may be defined as a secondarily normal charging process for increasing the state of charge of the battery 42 additionally. Step S178 provides a determination unit for determining the end timing of the normal charging process. Thus, in the present embodiment, the end timing of the rapid charging process and the end timing of the normal charging process are determined based on the state of charge in the battery 42.

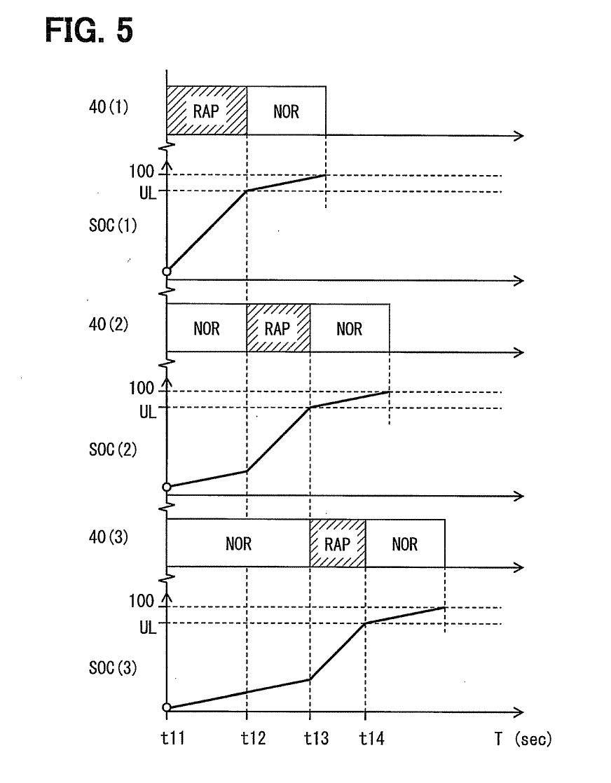

FIG. 5 shows an example of the operation of the charging system 10 according to the present embodiment. In FIG. 5, three vehicles 40(1), 40(2), 40(3) are connected to the station 20. At time t11, the system 10 starts to execute the charging control. The charging order of the first vehicle 40(1) has the highest priority. The charging order of the third vehicle 40(3) has the lowest priority.

At time t11, the system 10 provides the rapid charging process with respect to the first vehicle 40(1). In this case, the system 10 can not provide the rapid charging process with respect to the second and third vehicles 40(2), 40(3). In this case, the system 10 can provide the normal charging process with respect to the second and third vehicles 40(2), 40(3). Thus, from time t11, the system 10 starts to provide the normal charging process with respect to the second and third vehicles 40(2), 40(3). As a result, the second and third vehicles 40(2), 40(3) that wait for the rapid charging process are charged in the normal speed charging manner. Thus, without wasting time, the waiting time of the second and third vehicles 40(2), 40(3) is effectively used for charging in the normal charging process.

At time t12, the state of charge SOC(1) of the first vehicle 40(1) reaches the upper limit UL. Thus, the rapid charging process of the first vehicle 40(1) is completed. From time t12, the first vehicle 40(1) is charged in the normal charging process. The normal charging process of the first vehicle 40(1) after the rapid charging process ends is continuously executed until the battery 42 of the first vehicle 40(1) is fully charged. From time t12, the second vehicle 40(2) is charged in the rapid charging manner. The third vehicle 40(3) is successively charged in the normal charging process.

At time t13, the state of charge SOC(2) of the second vehicle 40(2) reaches the upper limit UL. Thus, the rapid charging process of the second vehicle 40(2) is completed. From time t13, the second vehicle 40(2) is charged in the normal charging process. The normal charging process of the second vehicle 40(2) after the rapid charging process ends is continuously executed until the battery 42 of the second vehicle 40(2) is fully charged. From time t13, the third vehicle 40(3) is charged in the rapid charging manner.

At time t14, the state of charge SOC(3) of the third vehicle 40(3) reaches the upper limit UL. Thus, the rapid charging process of the third vehicle 40(3) is completed. From time t14, the third vehicle 40(3) is charged in the normal charging process. The normal charging process of the third vehicle 40(3) after the rapid charging process ends is continuously executed until the battery 42 of the third vehicle 40(3) is fully charged.

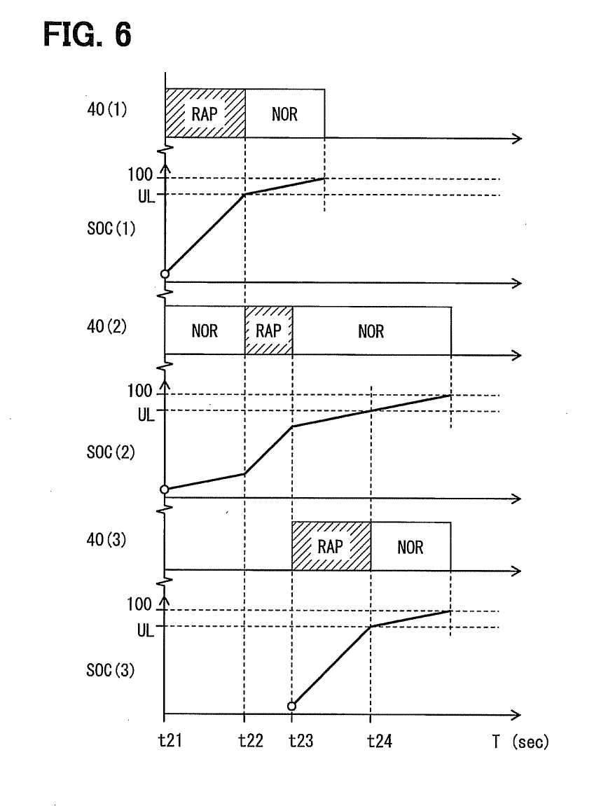

FIG. 6 shows an example of the operation of the charging system according to the present embodiment. In FIG. 6, at time t23, the third vehicle 40(3) is additionally connected to the station 20. The charging order of the first vehicle 40(1) is higher than the second vehicle 40(2). The charging order of the third vehicle 40(3) is higher than the second vehicle 40(2).

From time t21, the first vehicle 40(1) is charged in the rapid charging process. From time t21, the second vehicle 40(2) is charged in the normal charging process. At time t22, the system 10 switches from the rapid charging process to the normal charging process with respect to the first vehicle 40(1). From time t22, the second vehicle 40(2) is charged in the rapid charging process.

At time t23, the third vehicle 40(3) is connected to the station 20. The vehicular control device 48 of the third vehicle 40(3) transmits the conditions to the station control device 26. Thus, the station control device 26 obtains the conditions additionally, and the device 26 sets the electricity supplying plan again. As a result, at time t23, the third vehicle 40(3) is charged in the rapid charging process. At the same time, the second vehicle 40(2) is charged in the normal charging process again.

At time t24, the state of charge SOC(3) of the third vehicle 40(3) reaches the upper limit UL. Thus, the rapid charging process of the third vehicle 40(3) is completed. From time t24, the third vehicle 40(3) is charged in the normal charging process again. On the other hand, at time t24, the state of charge SOC(2) of the second vehicle 40(2) reaches the upper limit UL. After time t24, the second vehicle 40(2) is charged successively in the normal charging process.

### Second Embodiment

A second embodiment is a modification of the first embodiment. In the first embodiment, the selective distributer 25 provides the selective electricity supply passage for the rapid charging device 23. In the second embodiment, multiple rapid relays 47 mounted on multiple vehicles 40, respectively, are controlled in cooperation with each other, so that the selective electricity supply passage for the rapid charging device 23 is provided. Further, in the first embodiment, the electricity supply planning unit 51 and the switching control unit 52 are arranged in the station control device 26. In the second embodiment, the electricity supply planning unit 251 and the switching control unit 252 are arranged in the vehicle 40.

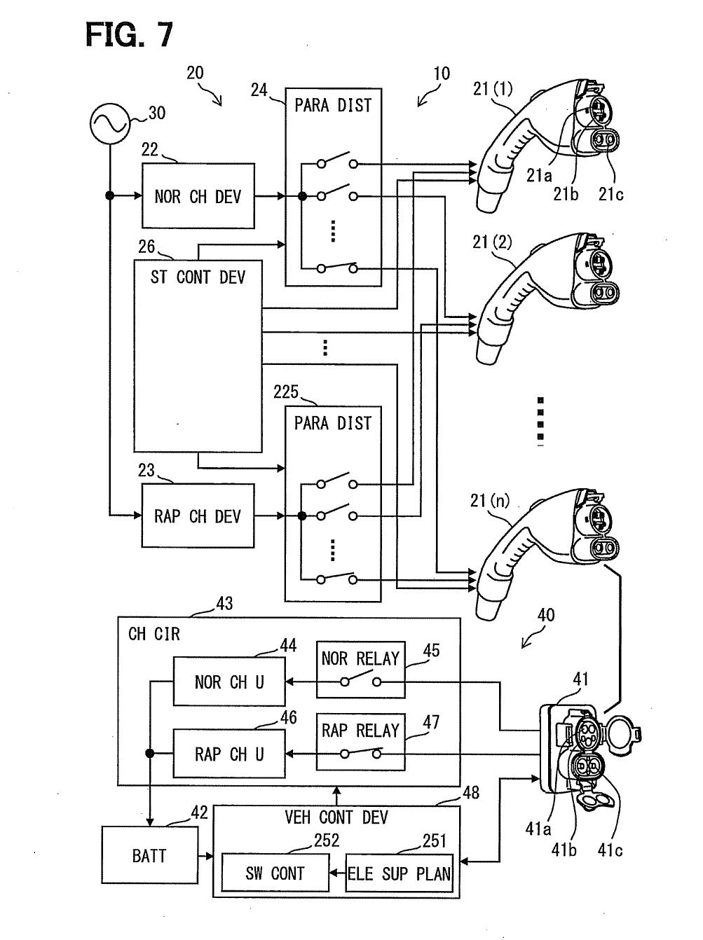

In FIG. 7, the parallel distributer 225 is arranged between the rapid charging device 23 and multiple connectors 21. The parallel distributer 225 has a similar structure as the parallel distributer 24. The station control device 26 controls the parallel distributers 24, 225 according to an instruction from the vehicular control device 48. The vehicular control device 48 includes the electricity supply planning unit 251 and the switching control unit 252. In the present embodiment, the station control device 26 and the vehicular control device 48 provide a control apparatus for controlling the charging system 10.

The electricity supply planning unit 251 has a function corresponding to the electricity supply planning unit 51. The electricity supply planning unit 251 obtains data including conditions from other vehicles 40 connected to the station 20. Further, the electricity supply planning unit 251 of one vehicle 40 in cooperation with other electricity supply planning units 251 mounted on other vehicles 40 connected to the station 20 sets a common electricity supplying plan. For example, one electricity supply planning unit 51 functions as a representative of the vehicles 40, and other electricity supply planning unit 51 functions as a subsidiary of the vehicles 40.

The switching control unit 252 has a function corresponding to the switching control unit 52. The switching control unit 252 sends a signal for controlling the parallel distributers 24, 225 to the station control device 26. Thus, the switching control unit 252 controls the parallel distributers 24, 225 via the station control device 26. The switching control unit 252 controls the rapid relay 47 so as to form the selective electricity supplying passage for the rapid charging device 23.

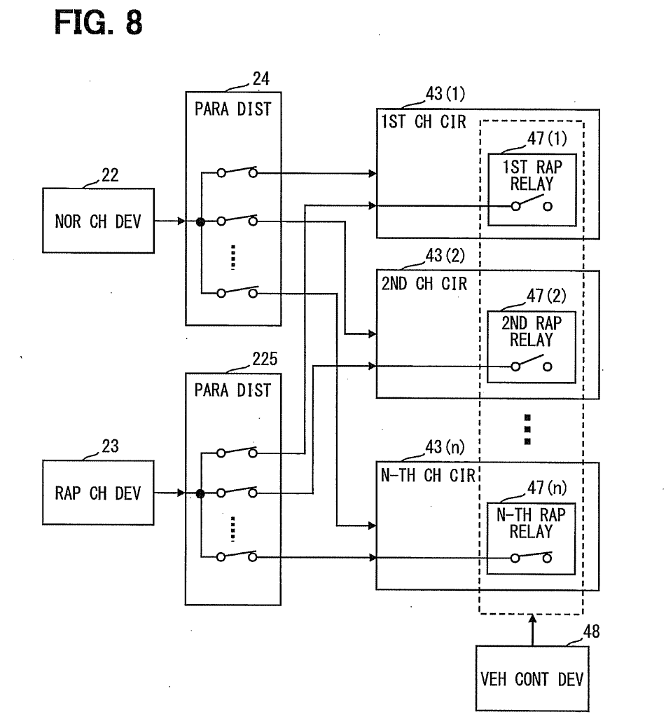

As shown in FIG. 8, in this embodiment, multiple electricity supplying passages are formed in parallel between the normal charging device 22 and multiple charging circuits 43. Further, multiple electricity supplying passages, which are selectively switchable, are formed between the rapid charging device 23 and multiple charging circuits 43. The rapid relay 47 arranged in the charging circuit 43 selectively closes multiple electricity supplying passages for the rapid charging process. In this case, the electricity supplying passage, which is selectively switchable, is formed between the rapid charging device 23 and multiple vehicles 40 using multiple rapid relays 47 mounted on multiple vehicles, respectively. Thus, the parallel distributer 225 and multiple rapid relays 47 provide a first distributer. The parallel distributer 24 provides a second distributer.

In FIG. 8, only the electricity supplying passage between the rapid charging device 23 and the n-th charging circuit 43(n) is closed. In this case, only the n-th charging circuit 43(n) can execute the rapid charging process. The first charging circuit 43(1), the second charging circuit 43(2) and the like can not execute the rapid charging process. Instead, the first charging circuit 43(1), the second charging circuit 43(2) and the like can execute the normal charging process.

### Other Embodiments

For example, the control apparatus provides a means and a function, which are realized by only a software, only a hardware or a combination of the software and the hardware. For example, the control apparatus may be provided by an analog circuit.

In the above embodiments, the data communication between the station control device 26 and the vehicular control device 48 is performed via a signal line including the communication terminals 21b, 41b. The communication terminals 21b, 41b may function as the power terminals 21a, 41a for the normal charging process. In the above embodiments, the communication terminals 21b, 41b are used for both of the normal charging process and the rapid charging process. Alternatively, the data communication may be performed via a power line including the power terminals 21a, 41a or a power line including the power terminals 21c, 41c. The data communication via the power line is defined as a power line communication.

In the above embodiments, the station control device 26 or the vehicular control device 48 provides the electricity supplying planning units 51, 251 and the switching control units 52, 252. Alternatively, at least a part of the electricity supplying planning unit 51 and the switching control units 52 may be provided by another control device, which is arranged apart from the charging system 10. Another control device may be provided by a cloud computing system or a remote server, which is communicably connected to the station control device 26 and/or the vehicular control device 48 via a communication system.

In the above embodiments, the charging station 20 includes only one rapid charging device 23. Alternatively, the charging station 20 may include multiple rapid charging devices 23. In this case, when the number of vehicles 40 is larger than the number of rapid charging devices 23, the system 10 charges the vehicles efficiently.

A display may be arranged in the station 20, the connector 21 and/or the vehicle 40 so that the display displays the charging state. For example, the display may display an image for identifying a normal charging state, a rapid charging state and a no-charge state.

It is noted that a flowchart or the processing of the flowchart in the present application includes sections (also referred to as steps), each of which is represented, for instance, as S161. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A charging system for charging a plurality of batteries mounted on a plurality of electric vehicles, respectively, the charging system comprising:
a first distributer that provides a plurality of parallel electricity supplying passages, through which a normal speed charging device charges a part of the batteries in parallel in a normal speed charging process;
a second distributer that provides a selective electricity supplying passage, through which a rapid charging device charges one of the batteries selectively and switchably in a rapid charging process, the rapid charging device charging the one of the batteries with a charging speed higher than the normal speed charging device; and
a controller for controlling the first distributer and the second distributer, wherein:
the controller includes:
a charging order control device that controls the second distributer to switch the selective electricity supplying passage according to a charging order of the batteries in the rapid charging process, so that the rapid charging device executes the rapid charging process in turn;
a secondarily charging device that controls the normal speed charging device to secondarily charge the one of batteries in the normal speed charging process after the rapid charging device charges the one of batteries in the rapid charging process; and
an alternative charging device that controls the normal speed charging device to alternatively charge at least another one of batteries in the normal speed charging process when the at least another one of batteries waits for the rapid charging process.

2. The charging system according to claim 1, wherein:
the controller further includes a charging order setting device; and
the charging order setting device sets the charging order of the batteries in the rapid charging process according to at least one of a rank of an user of a vehicle, a departure time of the vehicle, an initial charging state of a battery of the vehicle, and a target charging state of the battery of the vehicle.

3. The charging system according to claim 1, wherein:
the controller further includes a restriction device; and
the restriction device restricts a number of the part of the batteries, which are charged with the normal speed charging device in the normal speed charging process, in such a manner that a total electricity supplied from a power source to the normal speed charging device and the rapid charging device falls below a predetermined upper limit.

4. The charging system according to claim 3, wherein:
the restriction device restricts the number of the part of the batteries according to the charging order.

5. The charging system according to claim 3, wherein:
the restriction device restricts a number of the at least another one of batteries, which is alternatively charged with the normal speed charging device in the normal speed charging process, according to the charging order.

6. The charging system according to claim 1, further comprising:
a connection device that includes a connector and an inlet, wherein:
each of the connector and the inlet includes a power terminal for connecting the normal speed charging device and a vehicle, and another power terminal for connecting the rapid charging device and the vehicle; and
the power terminal and the another power terminal are arranged next to each other.

7. The charging system according to claim 1, wherein:
the controller further includes a session management device; and
the session management device provides both of the normal speed charging process and the rapid charging process as a series of charging service for the one of the batteries.
